(19) United States
(12) Patent Application Publication
(10) Pub. No.: US 2025/0289254 A1
(43) Pub. Date: Sep. 18, 2025

(54) PRINTING DEVICE

(71) Applicant: SEIKO EPSON CORPORATION, Tokyo (JP)

(72) Inventor: Daisuke HIRUMA, MATSUMOTO-SHI (JP)

(21) Appl. No.: 19/078,746

(22) Filed: Mar. 13, 2025

(30) Foreign Application Priority Data
Mar. 15, 2024 (JP) 2024-040897

(51) Int. Cl. B41J 29/393; B41J 29/02

(52) U.S. Cl. CPC B41J 29/393; B41J 29/02; B41J 2029/3935

(57) ABSTRACT

A printing device 11 on which a colorimeter 50 that measures color of an image is mounted, the printing device 11 includes a printing section 13 that prints the image on a medium 99; a mounting section 17 that mounts the colorimeter; and a movement mechanism 18 that moves the mounting section toward and away from the medium, wherein the mounting section includes an accommodation member 21 that accommodates the colorimeter, and a pressing member 25 that is attached to the accommodation member and that presses the colorimeter so as to approach the medium.

The present application is based on, and claims priority from JP Application Serial Number 2024-040897, filed Mar. 15, 2024, the disclosure of which is hereby incorporated by reference herein in its entirety.

### BACKGROUND

### 1. Technical Field

The present disclosure relates to a printing device.

### 2. Related Art

JP-A-2021-139747 describes a printing device that includes a mounting section configured to mount a colorimeter and a movement mechanism that moves the mounting section toward and away from a medium. In the printing device, the movement mechanism causes the mounting section to approach the medium, thereby pressing the colorimeter against the medium. The colorimeter measures color of an image on the medium in a state of being pressed against the medium.

In such a printing device, when the colorimeter is strongly pressed against the medium, the posture of the colorimeter may be inclined. In this case, the printing device may not be able to measure color of the image with high accuracy using the colorimeter.

### SUMMARY

A printing device for overcoming the above-described problem is a printing device on which a colorimeter that measures color of an image is mounted, the printing device including a printing section that prints the image on a medium; a mounting section that mounts the colorimeter; and a movement mechanism that moves the mounting section toward and away from the medium, wherein the mounting section includes an accommodation member that accommodates the colorimeter, and a pressing member that is attached to the accommodation member and that presses the colorimeter so as to approach the medium.

### BRIEF DESCRIPTION OF THE DRAWINGS

FIG. 1 is a front view showing an embodiment of a printing device.

FIG. 2 is a side view showing an embodiment of a colorimeter.

FIG. 3 is a bottom view of a mounting section.

FIG. 4 is a side view of the mounting section.

FIG. 5 is a side view in which a cover is opened from a state shown in FIG. 4.

FIG. 6 is a front view in which a movement mechanism causes the mounting section to approach a medium from a state shown in FIG. 1.

FIG. 7 is a front view showing a modification of the printing device.

### DESCRIPTION OF EMBODIMENTS

An embodiment of a printing device will be described below with reference to the drawings. The printing device is, for example, an inkjet type printer that prints images such as characters and photographs by ejecting ink, which is an example of liquid, onto a medium such as paper sheet, film, or fabric. The printing device is configured to be capable of mounting a colorimeter that measures color of the image.

### Printing Device

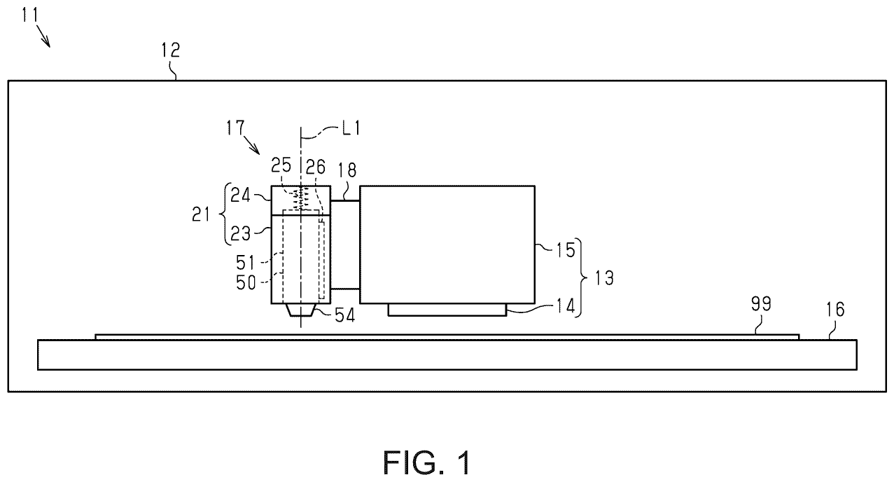

As shown in FIG. 1, a printing device 11 includes a housing 12.

The printing device 11 includes a printing section 13. The printing section 13 is accommodated in the housing 12. The printing section 13 is configured to print an image on a medium 99. In one example, the printing section 13 prints an image on the medium 99 by ejecting liquid onto the medium 99. The printing section 13 is, for example, a serial head type that scans the medium 99. The printing section 13 may be a line head type capable of ejecting liquid simultaneously across a width of the medium 99. The printing section 13 is not limited to ink, and may be configured to print an image using toner.

The printing section 13 includes a head 14. The head 14 is configured to eject liquid. The printing section 13 prints an image on the medium 99 by the head 14 ejecting liquid onto the medium 99.

The printing section 13 includes a carriage 15. The head 14 is mounted on the carriage 15. The carriage 15 is configured to scan relative to the medium 99. As the carriage 15 scans, the head 14 can eject liquid across a width of the medium 99.

The printing device 11 includes a support section 16. The support section 16 is accommodated in the housing 12. The support section 16 is configured to support the medium 99. The support section 16 is positioned so as to face the printing section 13. The support section 16 supports the medium 99 to be printed by the printing section 13.

The printing device 11 includes a mounting section 17. The mounting section 17 is accommodated in the housing 12. The mounting section 17 is configured to mount a colorimeter 50. The mounting section 17 is configured so that the colorimeter 50 can be detachably attached thereto. The mounting section 17 will be described later.

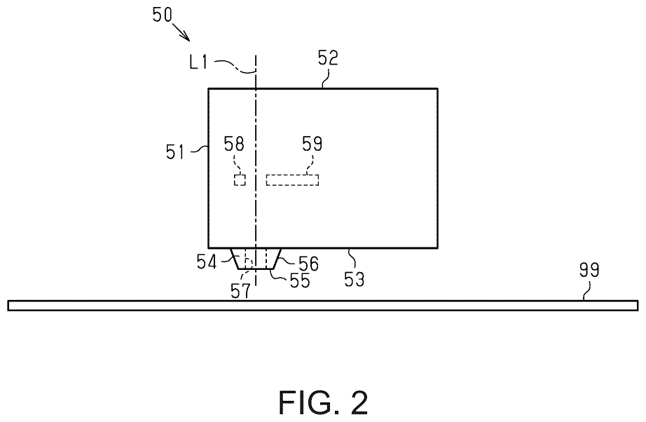

As shown in FIG. 2, the colorimeter 50 is configured to measure color of an image of the medium 99. The colorimeter 50 is pressed against the medium 99 to measure color of an image. In one example, the colorimeter 50 measures color of an image by being pressed against the medium 99 supported on the support section 16.

The colorimeter 50 includes a case 51. The case 51 includes a plurality of surfaces. In one example, the case 51 has a rectangular parallelepiped shape. The case 51 includes, for example, six surfaces. The plurality of surfaces of case 51 include a first surface 52 and a second surface 53. The first surface 52 and the second surface 53 are surfaces of the case 51 that face in opposite directions. The second surface 53 faces the medium 99 in a state where the colorimeter 50 is mounted on the mounting section 17. In one example, the second surface 53 faces downward when the colorimeter 50 is mounted on the mounting section 17. The first surface 52 faces upward when the colorimeter 50 is mounted on the mounting section 17.

The case 51 includes a contact portion 54. The contact portion 54 is a portion of the case 51 that is pressed against the medium 99. The contact portion 54 is a portion of the case 51 that protrudes toward the medium 99. The contact portion 54 protrudes from the second surface 53. The contact portion 54 protrudes from the second surface 53 in a truncated cone shape, for example.

The contact portion 54 includes a contact surface 55. The contact surface 55 is a surface that comes into contact with the medium 99. The contact surface 55 is a tip end surface of the contact portion 54. The contact portion 54 includes a protruding surface 56. The protruding surface 56 is a surface connected to the contact surface 55. The protruding surface 56 is a surface connected to the second surface 53. The protruding surface 56 is, for example, inclined with respect to the contact surface 55. The protruding surface 56 may be perpendicular to the contact surface 55. A color measurement port 57 is opened in the contact portion 54. Specifically, the color measurement port 57 is opened in the contact surface 55. The colorimeter 50 measures color of an image through the color measurement port 57.

The color measurement port 57 opens with an axis line L1 as the center. The axis line L1 is an imaginary axis extending perpendicular to the contact surface 55. The axis line L1 is the central axis of the contact portion 54. Therefore, the axis line L1 passes through the center of the contact portion 54. The colorimeter 50 measures color of an image positioned on the axis line L1 through the color measurement port 57. By making the axis line L1 perpendicular to the medium 99, the colorimeter 50 can measure color of an image with high accuracy.

The colorimeter 50 includes a light source 58. The light source 58 is accommodated in the case 51. The light source 58 irradiates light to an image through the color measurement port 57. The light source 58 is, for example, a light emitting diode.

The colorimeter 50 includes a light receiving sensor 59. The light receiving sensor 59 is accommodated in the case 51. The light receiving sensor 59 receives light from an image through the color measurement port 57. Specifically, the light receiving sensor 59 receives reflection light of an image by the light source 58. By this, the colorimeter 50 measures color of an image. The light receiving sensor 59 is desirably arranged on the axis line L1. The light source 58 may irradiate light onto the medium 99 from the periphery centered on the axis line L1. The light source 58 may be arranged around the light receiving sensor 59.

The colorimeter 50 can measure color independently without being mounted on the printing device 11. Therefore, it is also possible to measure color on the printing device 11 and compare it with a value obtained by measuring color at a place away from the printing device 11. By using the same colorimeter 50 to measure color, the values obtained by color measurement can be used without taking into account the individual differences of the colorimeter 50.

The colorimeter 50 can be manually operated, but when the colorimeter 50 is mounted on the printing device 11, the printing device 11 may control a color measurement operation or the like. The colorimeter 50 is capable of sending and receiving control information and color measurement data with the printing device 11 via wireless communication, but when mounted on the printing device 11, it can also be connected via a wired connection and sending and receiving control information and color measurement data with the printing device 11 via wired communication.

As shown in FIG. 1, the printing device 11 includes a movement mechanism 18. The movement mechanism 18 is accommodated in the housing 12. The movement mechanism 18 is attached to the mounting section 17. The movement mechanism 18 is configured to move the mounting section 17. Specifically, the movement mechanism 18 moves the mounting section 17 toward and away from the medium 99. In one example, the movement mechanism 18 raises and lowers the mounting section 17.

The movement mechanism 18 moves the mounting section 17 to move the colorimeter 50 toward and away from the medium 99. The movement mechanism 18 presses the colorimeter 50 against the medium 99 by moving the mounting section 17 toward the medium 99. In one example, the movement mechanism 18 presses the colorimeter 50 against the medium 99 by lowering the mounting section 17. Specifically, the movement mechanism 18 presses the contact surface 55 against the medium 99 by lowering the mounting section 17. The colorimeter 50 is pressed against the medium 99, thereby measuring color of an image with high accuracy. The movement mechanism 18 may be composed of a rack and pinion, a ball screw, or a rotation cam.

When the printing section 13 prints on the medium 99, the movement mechanism 18 may move the mounting section 17 so that the colorimeter 50 moves away from the medium 99. For example, the movement mechanism 18 may raise the mounting section 17 when the printing section 13 prints on the medium 99. By this, a possibility that the mounting section 17, the colorimeter 50, and the like interfere with the medium 99 during printing is reduced.

### Mounting Section

Next, the mounting section 17 will be described.

The mounting section 17 mounts the colorimeter 50 so that the colorimeter 50 protrudes toward the medium 99. Specifically, the mounting section 17 mounts the colorimeter 50 such that the contact portion 54 protrudes toward the support section 16. By this, when the mounting section 17 approaches the medium 99, the contact portion 54 is pressed against the medium 99.

The mounting section 17 mounts the colorimeter 50 in a state in which the colorimeter 50 is movable. Specifically, the mounting section 17 mounts the colorimeter 50 in a movable state so that the colorimeter 50 can move toward and away from the medium 99. In one example, the mounting section 17 mounts the colorimeter 50 in a state in which the colorimeter 50 can be raised and lowered. The mounting section 17 mounts the colorimeter 50 in a state in which the colorimeter 50 can slide up and down, for example. When the colorimeter 50 is strongly pressed against the medium 99, the colorimeter 50 rises in the mounting section 17. By this, the parallelism between the colorimeter 50 and the medium 99 is maintained.

The mounting section 17 is attached to the carriage 15. The mounting section 17 is attached to the carriage 15 via, for example, the movement mechanism 18. By this, the colorimeter 50 can scan the medium 99 together with the carriage 15. The printing device 11 can cause the colorimeter 50 to measure color of an image at an arbitrary position of the medium 99.

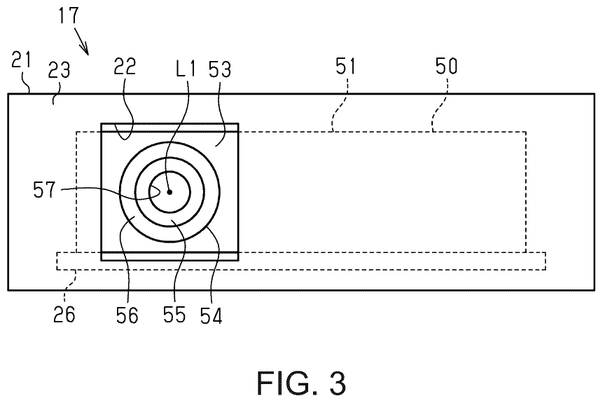

As shown in FIG. 3, the mounting section 17 includes an accommodation member 21. The accommodation member 21 is attached to the carriage 15 via the movement mechanism 18. The accommodation member 21 is configured to accommodate the colorimeter 50. The accommodation member 21 accommodates the colorimeter 50 in a movable state so that the colorimeter 50 can move toward and away from the medium 99. In one example, the accommodation member 21 accommodates the colorimeter 50 in a state in which the colorimeter 50 can be raised and lowered.

The accommodation member 21 accommodates the colorimeter 50 so that the contact portion 54 is exposed. The accommodation member 21 includes, for example, an exposure port 22. The exposure port 22 is an opening for exposing the colorimeter 50. Through the exposure port 22, the contact portion 54 protrudes from the accommodation member 21.

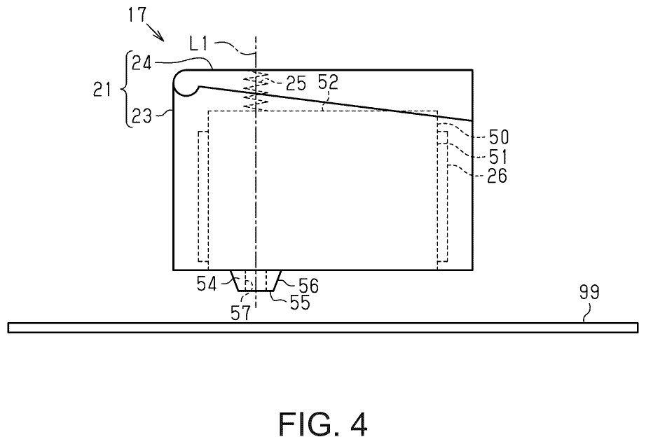

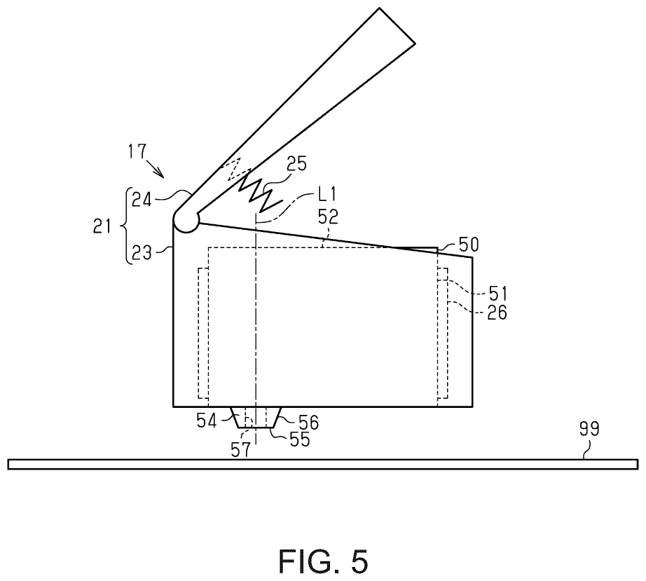

As shown in FIGS. 4 and 5, the accommodation member 21 includes an accommodation body 23 and a cover 24. The accommodation body 23 accommodates the colorimeter 50. The exposure port 22 is opened in the accommodation body 23. Specifically, the exposure port 22 is opened on a surface of the accommodation body 23 that faces the medium 99. The cover 24 is attached to the accommodation body 23. The cover 24 is configured to be openable and closable with respect to the accommodation body 23. When the cover 24 is opened, the colorimeter 50 can be attached to and detached from the accommodation body 23. The cover 24 covers the first surface 52 by closing. In one example, the cover 24 covers the colorimeter 50 from above by being closed. In FIG. 4, the cover 24 is closed. In FIG. 5, cover 24 is open.

The mounting section 17 includes a pressing member 25. The pressing member 25 is configured to press the colorimeter 50 against the medium 99. Specifically, the pressing member 25 presses the colorimeter 50 so as to press the contact portion 54 toward the medium 99. The pressing member 25 presses the colorimeter 50 so as to approach the medium 99. In one example, the pressing member 25 presses the colorimeter 50 downward. The pressing member 25 is, for example, a spring. The pressing member 25 only needs to be elastic, and may be a sponge, for example.

The pressing member 25 is attached to the accommodation member 21. Specifically, the pressing member 25 is attached to the cover 24. When the cover 24 is closed, the pressing member 25 comes into contact with the colorimeter 50. Specifically, when the cover 24 is closed, the pressing member 25 comes into contact with the first surface 52. At this time, the pressing member 25 presses the colorimeter 50 so that the second surface 53 is in close contact with the accommodation body 23. When mounting the colorimeter 50 to the mounting section 17, the pressing member 25 presses the colorimeter 50 so as to be in close contact with the accommodation body 23, but is in an expandable and contractible state so as to absorb an excessive load.

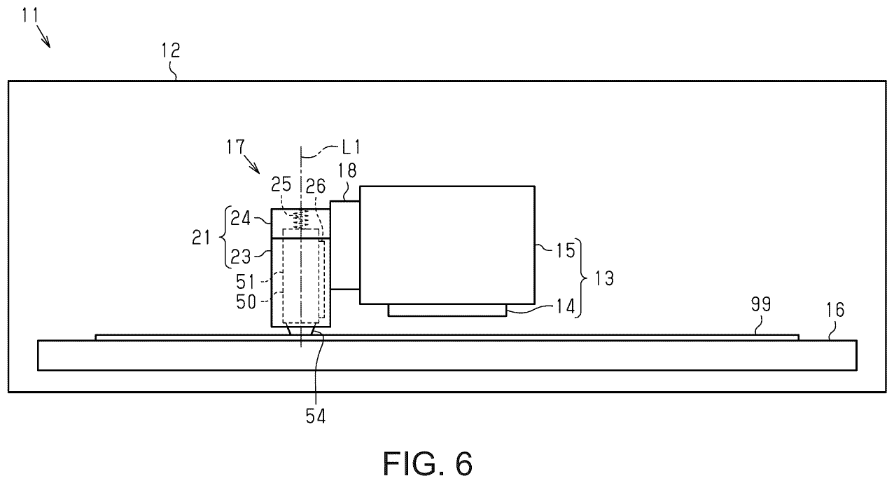

As shown in FIG. 6, when the movement mechanism 18 moves the mounting section 17 toward the medium 99, the contact portion 54 is pressed against the medium 99. At this time, the contact portion 54 may be strongly pressed against the medium 99 due to the thickness of the medium 99, undulation of the medium 99, or the like. When the contact portion 54 is pressed against the medium 99, the pressing member 25 contracts, causing the colorimeter 50 to be displaced. In one example, as the pressing member 25 contracts, the colorimeter 50 rises within the accommodation member 21. That is, the pressing member 25 expands and contracts so that the colorimeter 50 is not excessively pressed against the medium 99. Thus, the pressing member 25 appropriately presses the colorimeter 50 against the medium 99 while maintaining the parallelism between the colorimeter 50 and the medium 99. When the colorimeter 50 is fixed to the accommodation member 21, the mounting section 17 may be inclined or the colorimeter 50 may be inclined because the contact portion 54 is strongly pressed against the medium 99. Since the pressing member 25 absorbs an excessive load when the colorimeter 50 is pressed against the medium 99, the influence of a load received by the carriage 15 when the colorimeter 50 is pressed against the medium 99 is also reduced. By this, it is possible to appropriately maintain an interval between the carriage 15 and the support section 16.

The pressing member 25 is attached to the accommodation member 21 so as to be positioned on the axis line L1. It can be said that the accommodation member 21 accommodates the colorimeter 50 so that the pressing member 25 is positioned on the axis line L1. In this case, the pressing member 25 is positioned so as to overlap an image in a state where the colorimeter 50 measures color of the image. The pressing member 25 presses the colorimeter 50 in a direction in which the axis line L1 extends. That is, the pressing member 25 vertically presses a portion positioned directly above the contact portion 54 in the case 51. By this, the posture of the colorimeter 50 is easily stabilized.

The mounting section 17 may include a holding member 26. The holding member 26 is configured to hold the colorimeter 50. The holding member 26 is configured such that the colorimeter 50 is attached thereto. The colorimeter 50 is fixed to the holding member 26.

The holding member 26 is accommodated in the accommodation member 21. The holding member 26 is attached to the accommodation member 21. The holding member 26 is attached for movement relative to the accommodation member 21. Specifically, the holding member 26 is attached to the accommodation member 21 in a state in which the holding member 26 can move relative to the accommodation member 21 so as to move toward and away from the medium 99. In one example, the holding member 26 is attached to the accommodation body 23 in a state in which the holding member 26 can be raised and lowered within the accommodation member 21. The holding member 26 is attached to the accommodation body 23 in a vertically slidable state with respect to the accommodation body 23, for example, by engaging with the accommodation body 23.

The holding member 26 moves within the accommodation member 21 together with the colorimeter 50. For example, when the contact portion 54 is strongly pressed against the medium 99, the holding member 26 is displaced together with the colorimeter 50. By the holding member 26 holding the colorimeter 50, the posture of the colorimeter 50 is stabilized within the accommodation member 21.

### Operations and Effects of Embodiment

Next, operations and effects of the above-described embodiment will be described.
(1) The mounting section 17 includes the accommodation member 21 that accommodates the colorimeter 50 and the pressing member 25 that is attached to the accommodation member 21 and presses the colorimeter 50 so as to approach the medium 99. According to the above-described configuration, the colorimeter 50 is pressed against the medium 99 by the movement mechanism 18 causing the mounting section 17 to approach the medium 99. At this time, when the colorimeter 50 is strongly pressed against the medium 99, the pressing member 25 contracts, thereby displacing the colorimeter 50. This reduces a possibility that the colorimeter 50 is inclined. Therefore, the printing device 11 can accurately measure color of an image by the colorimeter 50.
(2) The mounting section 17 is attached to the carriage 15. According to the above-described configuration, the colorimeter 50 can measure color of an image at an arbitrary position on the medium 99 by moving the carriage 15.
(3) The mounting section 17 is attached to the carriage 15 via the movement mechanism 18. According to the above-described configuration, the colorimeter 50 can measure color of an image at an arbitrary position on the medium 99 by moving the carriage 15.
(4) The accommodation member 21 is attached to the carriage 15 via the movement mechanism 18. According to the above-described configuration, the colorimeter 50 can measure color of an image at an arbitrary position on the medium 99 by moving the carriage 15.
(5) The pressing member 25 is attached to the cover 24. According to the above-described configuration, the pressing member 25 can easily press the colorimeter 50.
(6) The accommodation member 21 accommodates the colorimeter 50 so that the pressing member 25 is positioned on the axis line L1. According to the above-described configuration, when the colorimeter 50 is pressed against the medium 99, the posture of the colorimeter 50 is likely to be stable.
(7) The holding member 26 is attached for movement relative to the accommodation member 21. The holding member 26 moves relative to the accommodation member 21 so as to move toward and away from the medium 99. According to the above-described configuration, the posture of the colorimeter 50 is likely to be stable by the holding member 26.

### Modifications

The above-described embodiment can be modified as follows. The above-described embodiment and the following modifications can be implemented in combination with each other to the extent that they are not technically contradictory.

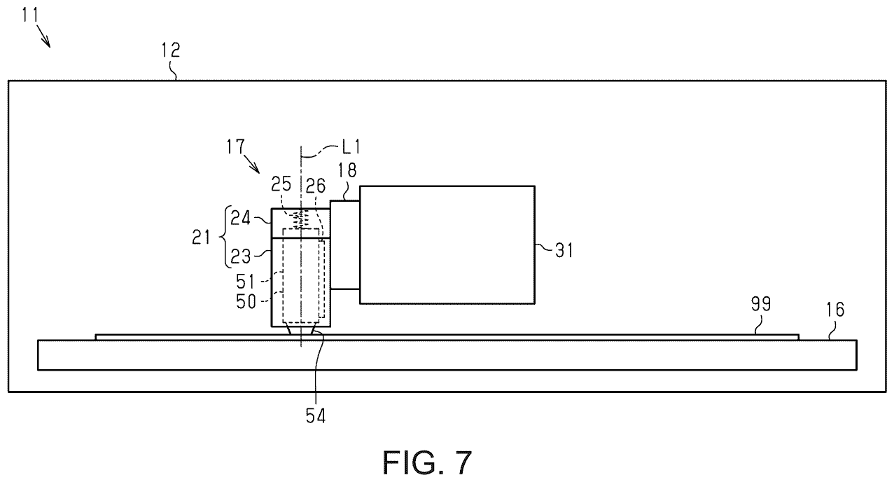

As shown in FIG. 7, the printing device 11 may include a movement body 31 different from the carriage 15 on which the head 14 is mounted. The movement body 31 is configured to move within the housing 12. The mounting section 17 may be attached to the movement body 31. For example, the mounting section 17 is attached to the movement body 31 via the movement mechanism 18. In this case, the printing device 11 can cause the colorimeter 50 to measure color of an image at an arbitrary position on the medium 99 by moving the movement body 31.

The mounting section 17 may be attached to the housing 12. For example, the mounting section 17 is attached to the housing 12 via the movement mechanism 18. In this case, the mounting section 17 moves up and down with respect to the housing 12. In this modification, for example, a user can cause the colorimeter 50 to measure color of an image by arranging the medium 99 directly below the mounting section 17.

The accommodation member 21 may be configured to engage the colorimeter 50. For example, the accommodation body 23 may be engaged with the colorimeter 50 so that the colorimeter 50 slides up and down. In this case, the posture of the colorimeter 50 is easily stabilized.

The printing device 11 may press the colorimeter 50 against the medium 99 by raising and lowering the carriage 15. The carriage 15 is generally configured to be able to move up and down in order to adjust the distance between the head 14 and the medium 99. Therefore, the colorimeter 50 can be raised and lowered by raising and lowering the carriage 15. In this case, the movement mechanism 18 is a mechanism for raising and lowering the carriage 15.

The mounting section 17 may include a cushioning material between the accommodation member 21 and the colorimeter 50 or between the accommodation member 21 and the holding member 26. In this case, the cushioning material can absorb vibration of the colorimeter 50 in the accommodation member 21. By this, the posture of the colorimeter 50 is more easily stabilized.

Liquid ejected by the head 14 is not limited to ink, and may be, for example, a liquid body in which a particle of a functional material is dispersed or mixed in liquid. For example, the head 14 may eject a liquid body containing a material such as electrode material or a pixel material used for manufacturing a liquid crystal display, an electroluminescent display, or a surface emitting display in a dispersed or dissolved form.

### Technical Ideas

Hereinafter, technical ideas grasped from the above-described embodiment and modifications, and operations and effects thereof, will be described.

(A) A printing device on which a colorimeter that measures color of an image is mounted, the printing device includes a printing section that prints the image on a medium; a mounting section that mounts the colorimeter; and a movement mechanism that moves the mounting section toward and away from the medium, wherein the mounting section includes an accommodation member that accommodates the colorimeter, and a pressing member that is attached to the accommodation member and that presses the colorimeter so as to approach the medium.

According to the above-described configuration, the colorimeter is pressed against the medium by the movement mechanism causing the mounting section to approach the medium. At this time, when the colorimeter is strongly pressed against the medium, the pressing member contracts, and thus the colorimeter is displaced. This reduces a possibility that the colorimeter is inclined. Therefore, the printing device can accurately measure color of the image by the colorimeter.

(B) The above-described printing device may be configured such that the printing section includes a head that ejects liquid and a carriage on which the head is mounted and the mounting section is attached to the carriage.

According to the above-described configuration, the colorimeter can measure color of the image at an arbitrary position of the medium by moving the carriage.

(C) The above-described printing device may be configured such that the mounting section is attached to the carriage via the movement mechanism.

According to the above-described configuration, the colorimeter can measure color of the image at an arbitrary position of the medium by moving the carriage.

(D) The above-described printing device may be configured such that the accommodation member is attached to the carriage via the movement mechanism.

According to the above-described configuration, the colorimeter can measure color of the image at an arbitrary position of the medium by moving the carriage.

(E) The above-described printing device may be configured such that the accommodation member includes an accommodation body that accommodates the colorimeter and a cover that is configured to open and close with respect to the accommodation body and the pressing member is attached to the cover.

According to the above-described configuration, the pressing member easily presses against the colorimeter.

(F) The above-described printing device may be configured such that the colorimeter includes a contact portion to be pressed against the medium, the contact portion includes a contact surface that comes into contact with the medium, and the accommodation member accommodates the colorimeter so that the pressing member is positioned on an axis line that passes through a center of the contact portion and that extends perpendicularly to the contact surface.

According to the above-described configuration, when the colorimeter is pressed against the medium, the posture of the colorimeter is easily stabilized.

(G) The above-described printing device may be configured such that the mounting section includes a holding member that holds the colorimeter and the holding member is attached for movement relative to the accommodation member and is configured to move relative to the accommodation member toward and away from the medium.

According to the above-described configuration, the posture of the colorimeter is easily stabilized by the holding member.

What is claimed is:

1. A printing device on which a colorimeter that measures color of an image is mounted, the printing device comprising:
a printing section that prints the image on a medium;
a mounting section that mounts the colorimeter; and
a movement mechanism that moves the mounting section toward and away from the medium, wherein
the mounting section includes
an accommodation member that accommodates the colorimeter, and
a pressing member that is attached to the accommodation member and that presses the colorimeter so as to approach the medium.

2. The printing device according to claim 1, wherein
the printing section includes
a head that ejects liquid and
a carriage on which the head is mounted and
the mounting section is attached to the carriage.

3. The printing device according to claim 2, wherein the mounting section is attached to the carriage via the movement mechanism.

4. The printing device according to claim 3, wherein the accommodation member is attached to the carriage via the movement mechanism.

5. The printing device according to claim 1, wherein
the accommodation member includes
an accommodation body that accommodates the colorimeter and
a cover that is configured to open and close with respect to the accommodation body and
the pressing member is attached to the cover.

6. The printing device according to claim 1, wherein
the colorimeter includes a contact portion to be pressed against the medium,
the contact portion includes a contact surface that comes into contact with the medium, and
the accommodation member accommodates the colorimeter so that the pressing member is positioned on an axis line that passes through a center of the contact portion and that extends perpendicularly to the contact surface.

7. The printing device according to claim 1, wherein
the mounting section includes a holding member that holds the colorimeter and
the holding member is attached for movement relative to the accommodation member and is configured to move relative to the accommodation member toward and away from the medium.
